(19) United States
(12) Patent Application Publication
(10) Pub. No.: US 2019/0128037 A1
(43) Pub. Date: May 2, 2019

(54) RESCUING AND POSITIONING ASSEMBLY

(71) Applicant: Wei Che Kuo, Taipei City (TW)

(72) Inventor: Wei Che Kuo, Taipei City (TW)

(21) Appl. No.: 15/794,018

(22) Filed: Oct. 26, 2017

(51) Int. Cl. E05F 5/08; E05F 3/22; E05F 1/12

(52) U.S. Cl. CPC E05F 5/08; E05Y 2900/132; E05F 1/12; E05F 3/22

(57) ABSTRACT

A door with a buffer device including a door frame; at least one door plate pivotally installed to a lateral side of the door frame, or two lateral sides of door frame, or the door plate; at least buffer device installed to a lateral side of the door plate. When the door plate is closed, the movable press plate will compress by the door frame so that the elastomers are compressed; as a result, in closing the door plate, the movable press plate will resist against the door frame or the door plate and the elastomers provide buffer force therebetween; when the door plate is closed, the movable press plate will tightly press the door frame or the door plate so that the door plate is completely attached to the door frame.

### FIELD OF THE INVENTION

The present invention relates to door assemblies, and in particular to door with a buffer device.

### BACKGROUND OF THE INVENTION

Generally, when a door is closed, the door plate must move to seal the door frame. However, because the door plate is often not well designed, there are some deviations between the door plate and the door frame so that the door plate will collide the door frame or they are not well combined as the door plate is closed. As a result, collision between the door plate and the door frame will make noises and induce gaps occurred between the door plate and the door frame so that the combination of the door plate and the door frame is not airtight. Some buffer devices are developed for resolving this problem. One example is shown in FIGS. 1 and 2, a door plate 11 is combined to a lateral side of the door frame 12. The door plate is pivotally moved towards or leaved from the door frame. Air tight rubber strips 13 may be installed on the contact surface of the door plate 11 or the door frame 12. However, this buffer structure only has the effect of reducing the colliding sound when the door plate 11 is closed, but it has not effect of buffering. Furthermore the lifetime time of rubber strip 13 is finite and thus after a period of using time, the rubber strip 13 cannot retain the effect of sound reduction in collision and the effect of retaining the air tightness.

### SUMMARY OF THE INVENTION

Accordingly, to improve above mentioned defects, the present invention provides a door with a buffer device, in that the door comprising: a door frame; at least one door plate pivotally installed to a lateral side of the door frame, or two lateral sides of door frame, or the door plate; at least buffer device installed to a lateral side of the door plate.

The buffer device includes a casing being an oblong structure and having a recess at one side thereof; two sides of the recess being formed with respective flanges including a lower flange and an upper flange; a movable press plate having an upper buckle and a lower buckle; the upper buckle has a U shape structure which is coupled to the upper flange of the casing and the lower buckle of the movable press plate being buckled with the lower flange of the recess of the casing; a plurality of elastomers being installed within the recess; one inner end of each elastomer resisting against an inner wall of the recess of the casing and one outer wall of each elastomer resisting against an inner wall of the movable press plate so that the movable press plate is compressible with respective to the casing and one outer part of the movable press plate is protruded out of the recess of the casing.

When the door plate is closed, the movable press plate will compress by the door frame so that the elastomers are compressed; as a result, in closing the door plate, the movable press plate will resist against the door frame or the door plate and the elastomers provide buffer force therebetween; when the door plate is closed, the movable press plate will tightly press the door frame or the door plate so that the door plate is completely attached to the door frame.

### BRIEF DESCRIPTION OF THE DRAWINGS

FIG. 1 shows a prior art buffer device of a door.

FIG. 2 is a cross sectional view of a prior art buffer device of a door.

FIG. 3 shows an assembled view of the buffer device of the present invention.

FIG. 3-1 shows an exploded view of the buffer device of the present invention.

FIG. 4 is a schematic view of the buffer device of the present invention.

FIG. 5 shows an application of the present invention.

FIG. 5-1 shows the detailed view about the application in FIG. 5.

FIG. 6 shows another application of the present invention, where the door is closed.

FIG. 6-1 shows the application of FIG. 6, wherein the door is opened.

FIG. 7 shows another application of the present invention, where the door is closed.

FIG. 7-1 shows the application of FIG. 7, wherein the door is opened.

FIG. 8 shows another embodiment of the present invention.

FIG. 8-1 shows a further embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

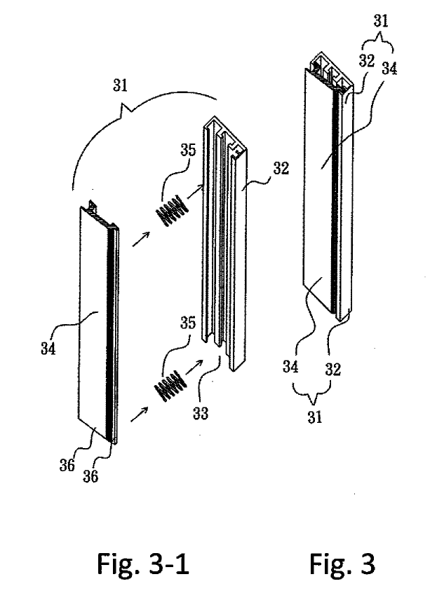

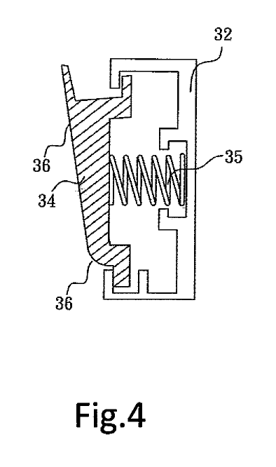

With reference to FIGS. 3 and 4, the buffer device 31 of the present invention is illustrated. In the present invention, the buffer device 31 includes the following elements.

A casing 32 has an oblong structure and has a recess 33 at one side thereof. Two sides of the recess 33 are formed with respective flanges including a lower flange and an upper flange.

A movable press plate 34 has an upper buckle and a lower buckle. The upper buckle has a U shape structure which is coupled to the upper flange of the casing 32 and the lower buckle of the movable press plate 34 is buckled with the lower flange of the recess 33 of the casing 32.

A plurality of elastomers 35 are installed within the recess 33 of the casing 32. One inner end of each elastomer 35 resists against an inner wall of the recess 33 of the casing 32 and one outer wall of each elastomer 35 resists against an inner wall of the movable press plate 34 so that the movable press plate 34 is compressible with respective to the casing 32 and one outer part of the movable press plate 34 is protruded out of the recess 33 of the casing 32.

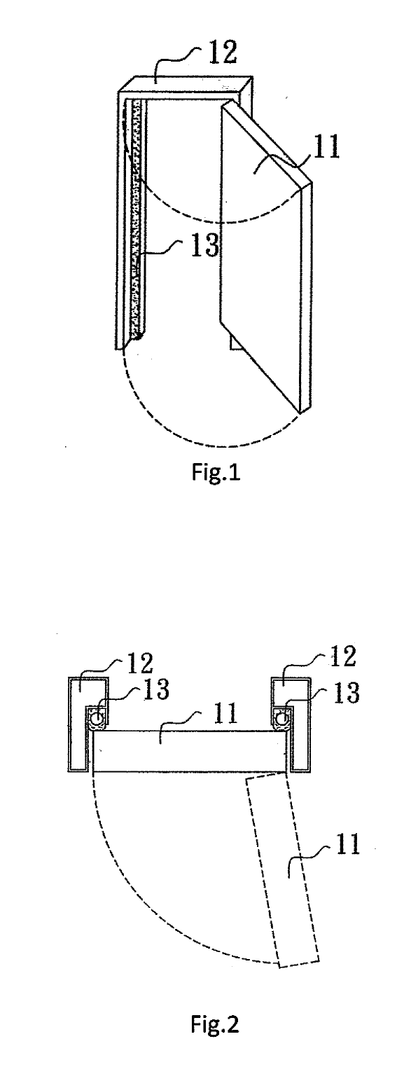

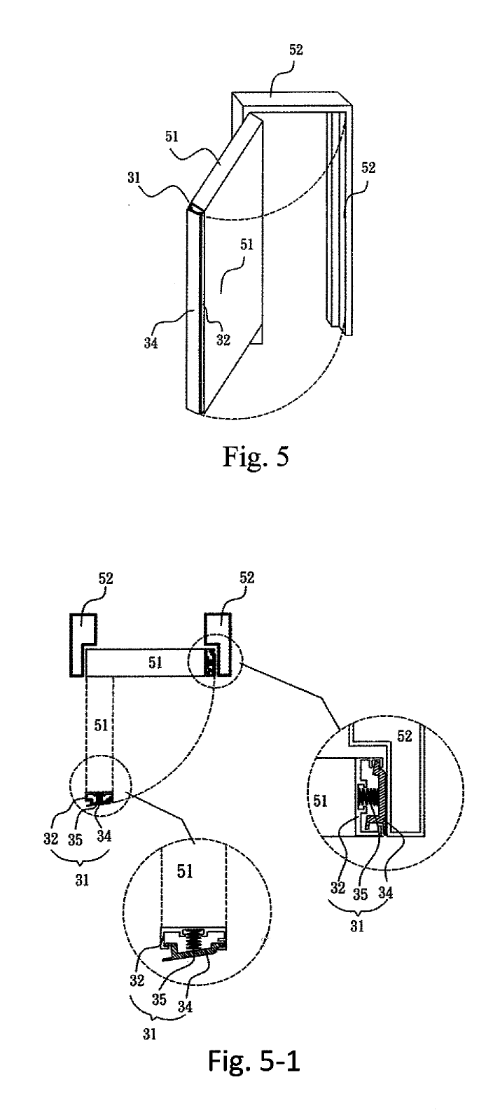

FIGS. 5 and 5-1, one embodiment of the present invention is illustrated

It is illustrated that the above mentioned buffer device 31 is installed to the door plate 51. The door plate 51 is pivotally installed to a door frame 52. The casing 32 of the buffer device 31 of the present invention is installed to the door frame 52 by using screws, buckles and so on. When the door plate 51 is closed, the movable press plate 34 will compress by the door frame 52 so that the elastomers 35 are compressed. As a result, in closing the door plate 51, the movable press plate 34 will resist against the door frame 52 and the elastomers 35 provide buffer force therebetween. When the door plate 51 is closed, the movable press plate 34 will tightly press the door frame 52 so that the door plate 51 is completely attached to the door frame 52. The combination between the door plate 51 ad the door frame 52 are airtight and sound proof.

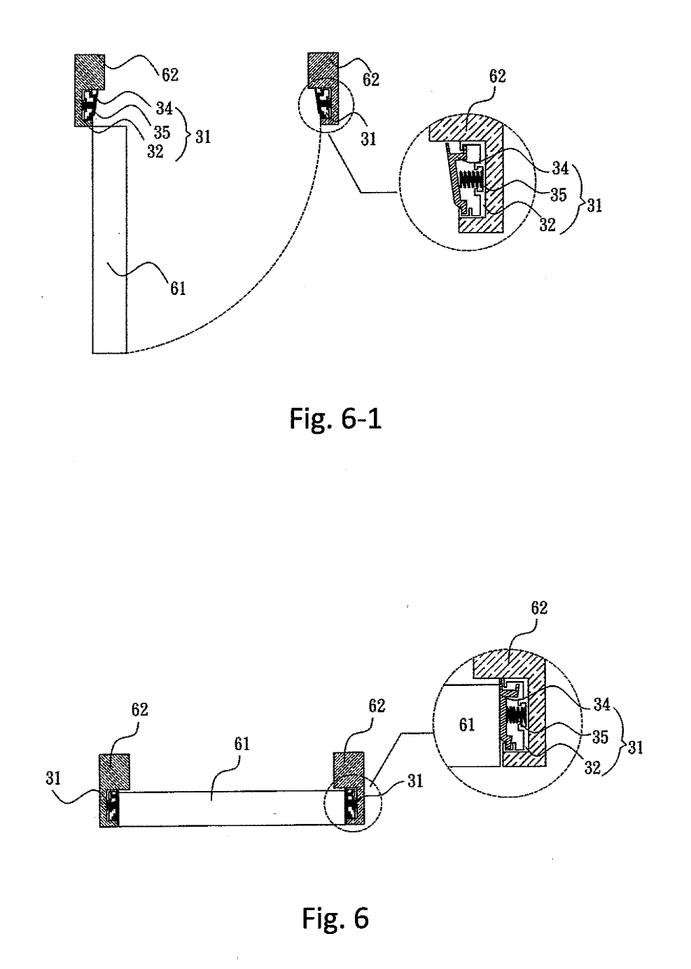

With reference to FIG. 6, the second embodiment of the present invention is illustrated. In this embodiment, two edges of a door frame 62 are installed with respective buffer devices 31. A corner of a door plate 61 is pivotally connected to one end of the door frame 52 aside one of a buffer device 31. When the door plate 61 is closed, the door plate 61 will contact the two movable press plates 34 on the two ends of the door frame 62 so as to compress the two movable press plates 34 which provide a buffer force to the door plate 61 by the elastic force from the elastomers 35. After the door plate 61 is completely closed, the connection between the door plate 61 and the door frame 62 are airtight and proof due to the elastic forces from the elastomers 35.

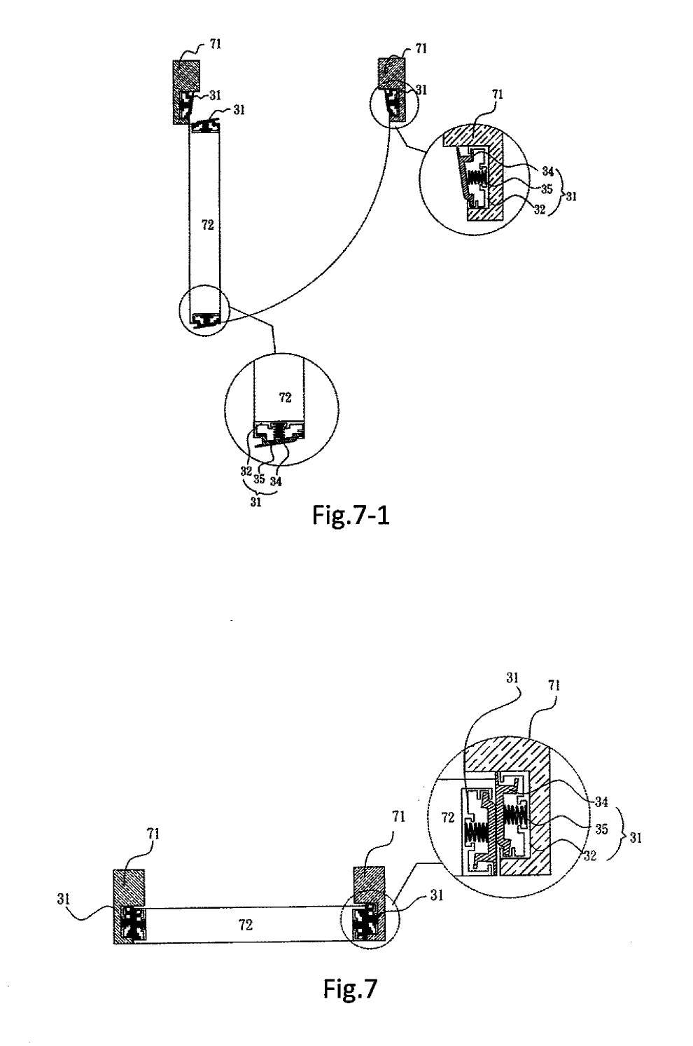

With reference to FIG. 7, a third embodiment of the present invention is illustrated. In this embodiment, two edges of a door frame 72 are installed with respective buffer devices 31, and two ends of the door plate 71 are also installed with respective buffer devices 31. A corner of a door plate 71 is pivotally connected to one end of the door frame 72 aside one of a buffer device 31. When the door plate 71 is closed, the two movable press plates 34 of the door plate 71 will contact the two movable press plates 34 of the buffer devices 31 on the two ends of the door frame 72 so as to compress the two movable press plates 34 which provide a buffer force to the door plate 71 by the elastic force from the elastomers 35. After the door plate 71 is completely closed, the connection between the door plate 71 and the door frame 72 are airtight and proof due to the elastic forces from the elastomers 35 of the door plate 71 and the elastomers 35 of the door frame 72.

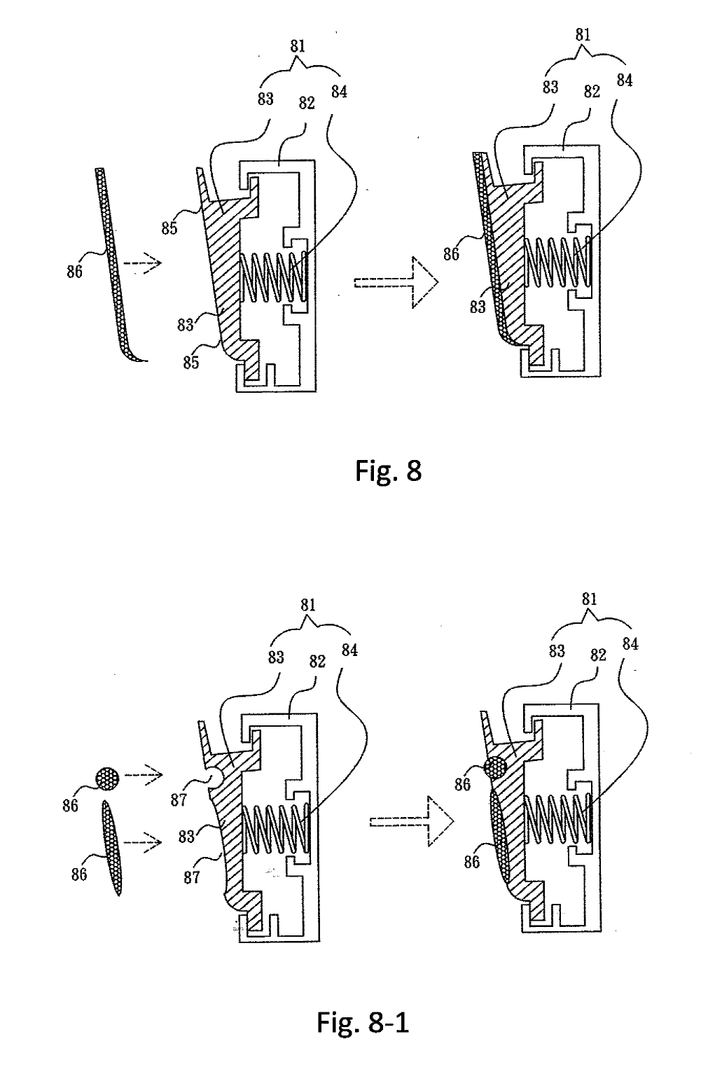

With reference to FIG. 8, the fourth embodiment of the present invention is illustrated. In this embodiment, the casing 82, movable press plate 83 and elastomer 84 of the buffer device 81 are almost identical to the casing 32, the movable press plate 34 and the elastomers 35 illustrated in FIG. 3, and thus the same elements are illustrated with the same numerals and the details of these elements will not be further described herein.

In this embodiment, an outer contact surface 85 of the movable press plate 83 is installed with an airtight rubber strip 86. When the door plate is closed, the rubber strip 86 will tightly resist against the door frame so as to form with an airtight and sound proof connection between the door plate and the door frame.

With reference to FIGS. 8-1, it is illustrated that in this the embodiment, the contact surfaces 85 of the movable press plate 83 can be formed with a groove 87 for receiving the rubber strip 86 so as to prevent the rubber strip 86 from falling out of the groove 87.

In this embodiment, the buffer device 31 may be installed with a door having two door plates. The buffer device 31 can be installed at the contact surface of the door plate and the door frame or be installed at the connect surfaces of the two door plates.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A door with a buffer device, comprising:
a door frame;
at least one door plate pivotally installed to the door frame;
at least buffer device installed to a lateral side of the door frame; the buffer device including:
a casing being an oblong structure and having a recess at one side thereof; two sides of the recess being formed with respective flanges including a lower flange and an upper flange;
a movable press plate having an upper buckle and a lower buckle; the upper buckle having a U shape structure which is coupled to the upper flange of the casing and the lower buckle of the movable press plate being buckled with the lower flange of the recess of the casing;
a plurality of elastomers being installed within the recess; one inner end of each elastomer resisting against an inner wall of the recess of the casing and one outer wall of each elastomer resisting against an inner wall of the movable press plate so that the movable press plate is compressible with respective to the casing and one outer part of the movable press plate is protruded out of the recess of the casing and
wherein when the door plate is closed, the movable press plate will compress by the door plate so that the elastomers are compressed; as a result, in closing the door plate, the movable press plate will resist against the door plate and the elastomers provide buffer force therebetween; when the door plate is closed, the movable press plate will tightly press the door plate so that the door plate is completely attached to the door frame.

2. The door with a buffer device as claimed in claim 1, wherein an outer surface of the movable press plate is an inclined surface.

3. The door with a buffer device as claimed in claim 1, wherein an outer surface of the movable press plate is a cambered surface.

4. The door with a buffer device as claimed in claim 1, wherein an outer surface of the movable press plate is installed with an airtight rubber strip.

5. The door with a buffer device as claimed in claim 4, wherein the outer surface of the movable press plate is formed with a groove for installing the airtight rubber strip.

6. The door with a buffer device as claimed in claim 1, wherein the elastomer is a spring.

7. A door with a buffer device, comprising:
a door frame;
a door plate pivotally installed to the door frame;
at least buffer device installed to a lateral side of the door plate; the buffer device including:
a casing being an oblong structure and having a recess at one side thereof; two sides of the recess being formed with respective flanges including a lower flange and an upper flange;
a movable press plate having an upper buckle and a lower buckle; the upper buckle has a U shape structure which is coupled to the upper flange of the casing and the lower buckle of the movable press plate being buckled with the lower flange of the recess of the casing;
a plurality of elastomers being installed within the recess; one inner end of each elastomer resisting against an inner wall of the recess of the casing and one outer wall of each elastomer resisting against an inner wall of the movable press plate so that the movable press plate is compressible with respective to the casing and one outer part of the movable press plate is protruded out of the recess of the casing and
wherein when the door plate is closed, the movable press plate will compress by the door frame so that the elastomers are compressed; as a result, in closing the door plate, the movable press plate will resist against the door frame and the elastomers provide buffer force therebetween; when the door plate is closed, the movable press plate will tightly press the door frame so that the door plate is completely attached to the door frame.

8. The door with a buffer device as claimed in claim 7, wherein an outer surface of the movable press plate is installed with an airtight rubber strip.

9. The door with a buffer device as claimed in claim 8, wherein the outer surface of the movable press plate is formed with a groove for installing the airtight rubber strip.

10. The door with a buffer device as claimed in claim 7, wherein the elastomer is a spring.

11. A door with a buffer device, comprising:
a door frame;
a door plate pivotally installed to the door frame;
two buffer device installed to different and opposite frame plates of the door frame; each of the buffer device including:
a casing being an oblong structure and having a recess at one side thereof; two sides of the recess being formed with respective flanges including a lower flange and an upper flange;
a movable press plate having an upper buckle and a lower buckle; the upper buckle has a U shape structure which is coupled to the upper flange of the casing and the lower buckle of the movable press plate being buckled with the lower flange of the recess of the casing;
a plurality of elastomers being installed within the recess; one inner end of each elastomer resisting against an inner wall of the recess of the casing and one outer wall of each elastomer resisting against an inner wall of the movable press plate so that the movable press plate is compressible with respective to the casing and one outer part of the movable press plate is protruded out of the recess of the casing and
wherein when the door plate is closed, the movable press plates will compress by the door plate so that the elastomers are compressed; as a result, in closing the door plate, the movable press plates will resist against the door plate and the elastomers provide buffer force therebetween; when the door plate is closed, the movable press plates will tightly press the door plate so that the door plate is completely attached to the door frame.

12. The door with a buffer device as claimed in claim 11, wherein an outer surface of the movable press plate is installed with an airtight rubber strip.

13. The door with a buffer device as claimed in claim 12, wherein the outer surface of the movable press plate is formed with a recess for installing the airtight rubber strip.

14. The door with a buffer device as claimed in claim 11, wherein the elastomer is a spring.
